(19) United States
(12) Patent Application Publication
(10) Pub. No.: US 2019/0083201 A1
(43) Pub. Date: Mar. 21, 2019

(54) MULTIFUNCTIONAL INTELLIGENT INVISIBLE ORTHODONTIC BRACES AND MANUFACTURING METHOD THEREOF

(71) Applicant: Guangzhou FAN YU MEDICAL TECHNOLOGY Co.,Ltd, Guangzhou (CN)

(72) Inventor: YI-SHI KE, Taoyuan (TW)

(73) Assignee: Guangzhou FAN YU MEDICAL TECHNOLOGY Co.,Ltd, Guangzhou (CN)

(21) Appl. No.: 16/021,039

(22) Filed: Jun. 28, 2018

(30) Foreign Application Priority Data
Sep. 19, 2017 (CN) 2017108470742

(51) Int. Cl. A61C 7/08; A61C 7/00

(52) U.S. Cl. CPC A61C 7/08; A61C 9/004; A61C 7/002

(57) ABSTRACT

Multifunctional intelligent invisible orthodontic braces include upper braces, lower braces and a chip. The upper braces and the lower braces respectively include an inner soft layer and an outer hard layer. The inner soft layer is attached to the periphery of the tooth. The outer hard layer is laminated on the outer side of the inner soft layer. The chip is arranged on the outer side of the outer hard layer or arranged between the inner soft layer and the outer hard layer. A monitor for detecting the wearing time is arranged in the chip. In the present invention, the inner soft layer is additionally arranged in the outer hard layer. This structure has the following advantages: the improved braces is a double-layer structure and is soft inside and hard outside. The attachment between the inner soft layer and the tooth is better.

### CROSS REFERENCE TO RELATED APPLICATIONS

This application is based upon and claims priority to Chinese Patent Application No. 2017108470742, field on Sep. 19, 2017, the entire content of which is incorporated herein by reference.

### TECHNICAL FIELD

The present invention relates to the field of medical products, particularly to multifunctional intelligent invisible orthodontic braces and a manufacturing method thereof.

### BACKGROUND

Braces are common tools used by people in orthodontia. Braces continuously force on the teeth to gradually align the teeth. The existing braces are various in structure and have the following defects:

(1) The existing braces are all single layer structures, the material is too hard. The rebound and deformation forces of the braces are insufficient. The rigidity of the braces is too high, the torque is insufficient. The braces get easily damaged when worn and used.

(2) The material of the existing braces are too hard, so the displacement effect of teeth is bad. The braces must first wrap around the teeth required to have orthodontic treatment. However, the material of the braces is too hard, other teeth are forced to move under the movement of the braces, thus making the orthodontic treatment worse. The braces are difficult to wear for users, which is inconvenient to use, and users will feel uncomfortable when using the braces.

(3) The service life of the existing braces is short because the retention period of the rebound deformation rate is about 3 days. The rebound force will become smaller after a long wearing time. For example, if a teeth displacement of 0.1 mm should be achieved by the first braces, due to the lack of rebound deformation force, only a teeth displacement of 0.07 mm can be achieved, the error is up to 0.03 mm. The second braces are required to be used, and the error of 0.06 (0.03+0.03) mm is required to be corrected by the rebound deformation force of the second braces. Therefore, the harder material may lead to lager correction error.

(4) The wearing status of a user using the existing braces cannot be known in real time, the braces wearing time of a customer cannot be monitored, affecting the treatment, and even the wearing time may be misreported, and may lead to medical disputes afterwards.

(5) The adsorption force on tooth by the existing braces is not insufficient because of the harder material. The braces get easily detached from the tooth during use. Meanwhile, additional parts are required to be arranged on the braces to enable the braces to grasp the tooth.

Thus, the current braces have the problems of uncomfortable use, insufficient adsorption force on the tooth, and being unable to monitor the teeth in real time.

### SUMMARY

The technical problem to be solved by the present invention is that the present braces have the problems of uncomfortable use, insufficient adsorption force on the tooth, and are unable to monitor the teeth in real time.

In order to solve the above-mentioned technical problems, the technical solution used in the present invention is to provide multifunctional intelligent invisible orthodontic braces, including upper braces and lower braces. The upper braces and the lower braces respectively include:

an inner soft layer attached to the periphery of the tooth;

an outer hard layer laminated on the outer side of the inner soft layer;

a chip arranged on the outer side of the outer hard layer or arranged between the inner soft layer and the outer hard layer, and a monitor for detecting the wearing time is provided in the chip.

Preferably, the inner side or the outer side of the outer hard layer is provided with a placement chamber. The chip is stuck in the placement chamber.

Preferably, the placement chamber is arranged on the lower braces or upper braces and is opposite to the position of incisors.

Preferably, the chip includes a rectangular flat plate and a circular platform arranged on the rectangular flat plate. The placement chamber is matched with the chip.

Preferably, the inner soft layer is press-fixed or detachably connected to the outer hard layer.

Preferably, the material used in the inner soft layer is polyethylene vinyl acetate. The material used in the outer hard layer is polyethylene or polyester.

Preferably, the chip is further provided with a pressure sensor, a temperature sensor and a vibration frequency detector successively connected to the monitor in series.

The present invention further provides a manufacturing method of multifunctional intelligent invisible orthodontic braces, including the following steps: performing press-fixation on the chip and the inner soft layer, and then tightly compressing the inner soft layer and the outer hard layer together. The pressing pressure is 3.5 to 4 pounds. The pressing temperature is 160° C.

Preferably, the chip is fixed on the chip platform first, then the inner soft layer is pressed on the chip; or the inner soft layer is placed on the profile frame first, and then the chip is pressed on the inner soft layer.

In the present invention, an inner soft layer is additionally arranged in the outer hard layer. This structure has the following advantages:

(1) The braces in the prior art are modified into a double layer structure. The outer hard layer and the inner soft layer make the braces both rigid and elastic. The inner soft layer plays a buffering role during overbite. It is more convenient to wear and does not get damaged easily.

(2) The inner soft layer has better warping ability for the tooth to be aligned. The movement of the tooth in orthodontic treatment has a little effect on the position of other teeth in the adjacent parts.

(3) The inner soft layer has a greater rebound force. The retention time of the rebound deformation force of the braces is longer. The service life is effectively improved and the orthodontic error of each of the braces is reduced. Therefore, after multiple braces are worn continuously, the accumulated error is also greatly reduced, effectively improving the orthodontic effect.

(4) The chip is additional provided to monitor the wearing time of a user, preventing the user from misreporting wearing time and affecting the treatment effect, avoiding the medical disputes.

(5) The adsorption force and friction force on tooth from the braces are increased, the braces do not get detached from the tooth easily. In the oral environment with a temperature of about 37.5° C. and humidity, the adsorption force enables the tooth and the braces to become integral as possible, which helps the braces to tightly grasp the tooth. Friction can effectively prevent the displacement between tooth and braces.

(6) The elasticity of the inner soft layer itself provides the tooth with a larger tooth torque space than the ordinary single-layer braces.

(7) The elasticity of the inner soft layer can effectively reduce the abrasion between the tooth and the braces, prolonging the service life. The wearing period may be extended to a week.

### BRIEF DESCRIPTION OF THE DRAWINGS

FIG. 1 is a structural schematic view of upper braces of the present invention.

FIG. 2 is a structural schematic view of the upper braces of the present invention from another perspective.

FIG. 3 is a structural schematic view of a chip of the present invention.

### DETAILED DESCRIPTION

The present invention will be described in detail below with reference to the specific embodiments and the drawings.

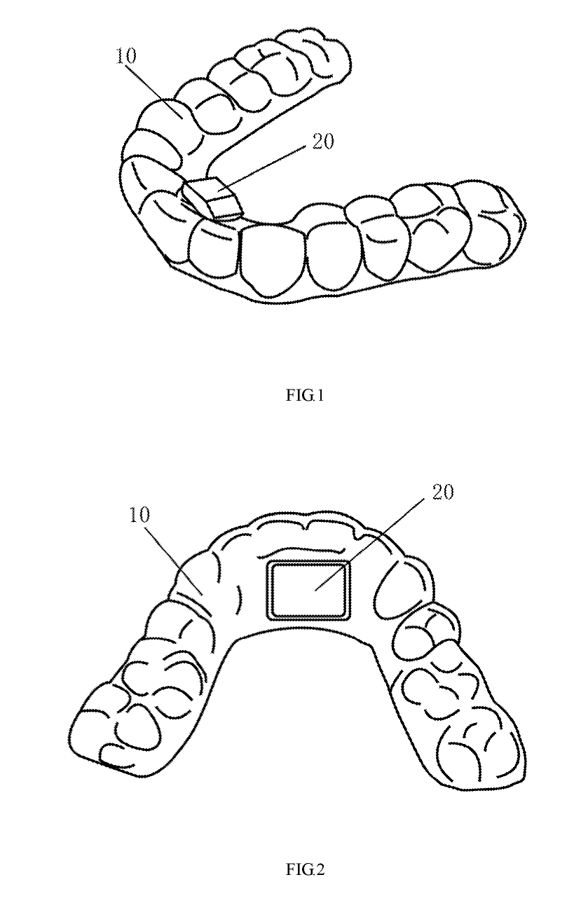

As shown in FIG. 1 and FIG. 2, the multifunctional intelligent invisible orthodontic braces provided by the present invention includes upper braces and lower braces. The upper braces and the lower braces include an inner soft layer, an outer hard layer 10 and a chip 20, respectively. The inner soft layer is attached to the periphery of the tooth. The outer hard layer 10 is laminated on the outer side of the inner soft layer. The chip 20 is arranged on the outer side of the outer hard layer 10 or is arranged between the inner soft layer and the outer hard layer 10. A monitor for detecting the wearing time is arranged in the chip 20. The inner soft layer is elastic and easy to wear, which may further reduces the abrasion between the tooth and braces. Chip 20 is built inside to accurately detect the wearing time.

Since the structures of the upper braces and lower braces are identical, only the upper braces will be described as an example in the drawings of the specification.

The inner side or the outer side of the outer hard layer 10 is provided with a placement chamber. Chip 20 is stuck in the placement chamber. The placement chamber ensures that the position of the chip 20 is fixed to prevent movement.

The placement chamber is arranged on the lower braces or upper braces and is opposite to the position of incisors. The placement chamber at this position is easy to be taken up. The overbite range of the tooth is largest. Therefore, the detection effect is best, and the examination on internal chip 20 is convenient.

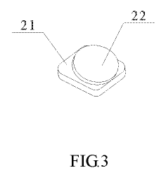

As shown in FIG. 3, the chip 20 includes a rectangular flat plate 21 and a circular platform 22 arranged on the rectangular flat plate 21. The placement chamber is matched with the chip 20. The ordinary chip 20 is in the form of a flat plate. However, multiplying the structure of the circular platform 22 can increase the complexity of the structural fit between the chip 20 and the placement chamber, further improving the stability of the position of the chip 20.

The inner soft layer is press-fixed or detachably connected to the outer hard layer 20.

The material used in inner soft layer is polyethylene vinyl acetate. The material used in the outer hard layer 10 is polyethylene or polyester. The inner soft layer has good elasticity, and is convenient to wear, thus reducing the discomfort of wearing, meanwhile, attaching to the tooth effectively, does not get detached from the tooth easily, and is safe and environmentally friendly.

The chip 20 is also provided with a pressure sensor, a temperature sensor and a vibration frequency detector successively connected to the monitor in series. When the braces are worn, the pressure sensor can detect the occlusal force of the tooth, the temperature sensor can detect the temperature of the oral cavity, and the vibration frequency detector can detect the vibration of the tongue. After the data acquired by the three sensors meet the predetermined standards, the monitor is turned on, the braces are considered as being in a wearing status, the detector starts timing, otherwise, timing is not started, preventing errors caused by external conditions and artificial factors.

The placement chamber is arranged on the inner side of the outer hard layer 10. The protruding structure arrangement of the placement chamber is convenient for the chip 20 to detect the vibration of the tongue and accurately detect the temperature in oral cavity.

The present invention also provides a manufacturing method of multifunctional intelligent invisible orthodontic braces, including the following steps: preforming press-fixation on the chip 20 and the inner soft layer, and then tightly compressing the inner soft layer and the outer hard layer 10. The pressing pressure is 3.5 to 4 pounds and the pressing temperature is 160° C. Since the size of the chip 20 is smaller, the inner soft layer is easier to press and fix the chip 20 with respect to the outer hard layer 10. The inner soft layer and the chip are fused and fixed under the action of pressure and temperature, so that the position of the chip 20 is accurate and not easy to displace. After the wearing period is ended, the chip 20 can be conveniently taken out of the inner soft layer for scanning detection.

Preferably, the chip 20 is fixed on the chip platform first, then the inner soft layer is pressed on the chip 20; or the inner soft layer is placed on the profile frame first, and then the chip 20 is pressed on the inner soft layer. The structure of the chip 20 is relatively flat, which is easy to be fixed. The inner soft layer can be directly pressed down on the chip platform. But the structure of the inner soft layer is more complicated, a profile frame matched the inner soft layer in shape is required to be used to accurately position the inner soft layer.

In the present invention, an inner soft layer is additionally provided in the outer hard layer. This structure has the following advantages:

(1) The braces in the prior art are modified into a double layer structure. The outer hard layer and the inner soft layer make the braces both rigid and elastic. The inner soft layer plays a buffering role in during overbite. It is more convenient to wear, and the braces do not get damaged easily.

(2) The inner soft layer has better warping ability for the tooth to be aligned. The movement of the tooth in orthodontic treatment has a little effect on the position of other teeth in the adjacent parts.

(3) The inner soft layer has a greater rebound force. The retention time of the rebound deformation force of the braces is longer. The service life is effectively improved and the orthodontic error of each of the braces is reduced. Therefore, after multiple braces are worn continuously, the accumulated error is also greatly reduced, effectively improving the orthodontic effect.

(4) The chip is additional provided to monitor the wearing time of a user, preventing the user from misreporting wearing time and affecting the treatment effect, avoiding the medical disputes.

(5) The adsorption force and friction force on tooth from the braces are increased, the braces do not detach from the tooth easily. In the oral environment with a temperature of about 37.5° C. and humidity, the adsorption force enables the tooth and the braces to become integral as possible, which helps the braces to tightly grasp the tooth. Friction can effectively prevent the displacement between tooth and braces.

(6) The elasticity of the inner soft layer itself provides the tooth with a larger tooth torque space than the ordinary single-layer braces.

(7) The elasticity of the inner soft layer can effectively reduce the abrasion between the tooth and the braces, prolonging the service life. The wearing period may be extended to a week.

The present invention is not limited to the above-mentioned preferred embodiments. Anybody should be aware that the structural changes made under the inspiration of the present invention, any technical solution that is the same or similar to the present invention shall fall within the protection scope of the present invention.

1. Multifunctional intelligent invisible orthodontic braces, comprising:
upper braces and lower braces, wherein the upper braces and the lower braces respectively comprise:
an inner soft layer attached to a periphery of tooth;
an outer hard layer laminated on an outer side of the inner soft layer;
a chip arranged on an outer side of the outer hard layer, or is arranged between the inner soft layer and the outer hard layer, and
a monitor for detecting a wearing time is provided in the chip.

2. The multifunctional intelligent invisible orthodontic braces of claim 1, wherein
an inner side or the outer side of the outer hard layer is provided with a placement chamber, the chip is stuck in the placement chamber.

3. The multifunctional intelligent invisible orthodontic braces of claim 2, wherein
the placement chamber is opposite to a position of incisors.

4. The multifunctional intelligent invisible orthodontic braces of claim 2, wherein
the chip comprises a rectangular flat plate and a circular platform arranged on the rectangular flat plate, the placement chamber is matched with the chip in shape.

5. The multifunctional intelligent invisible orthodontic braces of claim 1, wherein
the inner soft layer is press-fixed or detachably connected to the outer hard layer.

6. The multifunctional intelligent invisible orthodontic braces of claim 1, wherein
a material used in the inner soft layer is polyethylene vinyl acetate, a material used in the outer hard layer is polyethylene or polyester.

7. The multifunctional intelligent invisible orthodontic braces of claim 1, wherein
a pressure sensor, a temperature sensor, and a vibration frequency detector successively connected to the monitor in series are arranged on the chip.

8. A manufacturing method of multifunctional intelligent invisible orthodontic braces, comprising the following steps:
preforming press-fixation on a chip and an inner soft layer;
compressing the inner soft layer and an outer hard layer, wherein
a pressing pressure in the manufacturing method is 3.5 to 4 pounds, a pressing temperature in the manufacturing method is 160° C.

9. The manufacturing method of the multifunctional intelligent invisible orthodontic braces of claim 8, wherein
the chip is fixed on a chip platform first,
the inner soft layer is pressed on the chip afterwards; or
the inner soft layer is placed on a profile frame first,
the chip is pressed on the inner soft layer afterwards.
